(19) United States
(12) Patent Application Publication
(10) Pub. No.: US 2003/0141241 A1
(43) Pub. Date: Jul. 31, 2003

(54) Water-purifying filter element having surface holes for deep filtration

(76) Inventor: Chao-Jui Wu, Chiai (TW)

Correspondence Address: RABIN & BERDO, P.C., 1101 14th Street, N.W., Suite 500, Washington, DC, 20005, US

(21) Appl. No.: 10/057,936

(22) Filed: Jan. 29, 2002

(51) Int. Cl. B01D 39/00

(52) U.S. Cl. 210/489

(57) ABSTRACT

A water-purifying filter element is provided at an upper part of filtering materials therein with a plurality of surface holes of predetermined depths. The surface holes provide additional water passages for water introduced into the filter element via the upper part of the filtering materials, so that the introduced water are guided toward different directions to reduce a flow resistance thereof. The surface holes also increase impurity-deposit areas in the filter element to extend a service life of the filter element and speed up purification of water.

### BACKGROUND OF THE INVENTION

The present invention relates to a water-purifying filter element, and more particularly to a water-purifying filter element having surface holes of predetermined depths provided at an upper part thereof to provide additional water passages for water introduced thereinto, to reduce a flow resistance of the water, and to increase impurity-deposit areas of the filter element to extend a service life thereof.

The quick development of industrial fields results in various pollutions in our living environments. To fight against the deteriorated living environments, there are various kinds of products being continually invented to improve people's living quality. For example, efforts have been made to improve the very important water resources. The result of drinking polluted water is unpredictable.

Various filter elements are available in the markets to filter impurities in water to protect the quality of drinking water. FIG. 1 is a fragmentary sectional view of a conventional filter element 1. As can be seen from the figure, the filter element 1 includes multiple layers of overlaid filtering materials. Each layer of the filter materials has a specific compactness, and the compactness of the filtering materials decreases from a surface layer to deeper layers. Large-size impurities are filtered at the surface layer while other small-size impurities are gradually filtered at deeper layers, so that the water finally flown out of the filter element 1 is impurity-free.

However, the compactness of the surface layer of the conventional filter element 1 is so high that water introduced into the filter element 1 has a big flow resistance and requires a high water pressure to flow through the filter element 1. The large-size impurities in the water tend to quickly deposit on the surface layer of the filter element 1 to gradually reduce the volume of water that could pass through the filter element 1. To force the water through the filter element 1 under this condition, the pressure for introducing water into the filter element 1 must be increased accordingly, which results in continuous deposition and compression of the large-size impurities on and against the surface layer and quickly clogged and failed filter element 1. The service life of the filter element 1 is therefore largely reduced.

It is therefore desirable to develop an improved deep filter element to eliminate the drawbacks existing in the conventional filter element 1.

### SUMMARY OF THE INVENTION

A primary object of the present invention is to provide a water-purifying filter element that is able to guide water introduced thereinto toward different directions to reduce a flow resistance of the water, to increase impurity-deposit areas in the filter element, to extend a service life of the filter element, and to speed up purification of water.

To achieve the above and other objects, the present invention provides a water-purifying filter element having a plurality of surface holes of predetermined depths provided on an upper part of filtering materials in the filter element. The surface holes provide additional water passages for water introduced into the filter element via the upper part of the filtering materials, so that the introduced water flows into the filtering materials in different directions to reduce a flow resistance thereof. The surface holes also increase impurity-deposit areas in the filter element to extend a service life of the filter element and speed up purification of water with the filter element.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a conventional filter element;

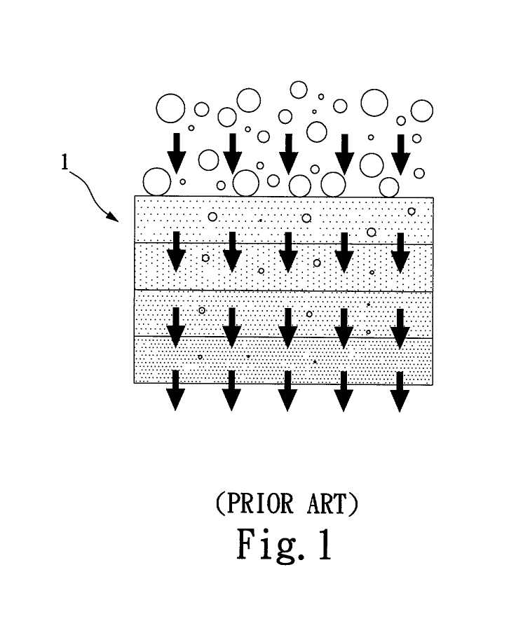

FIG. 2 is a fragmentary sectional view of a filter element according to the present invention; and

FIG. 3 is a partially enlarged view of FIG. 2.

### DETAILED DESCRIPTION OF THE PREFERRED EMBODIMENTS

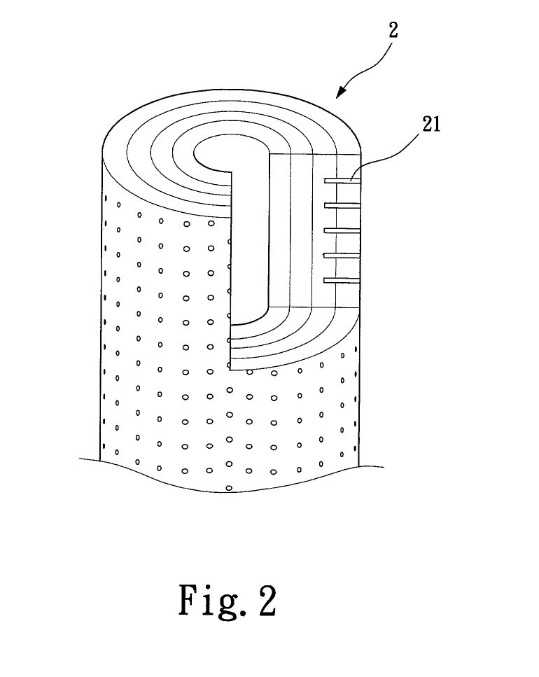

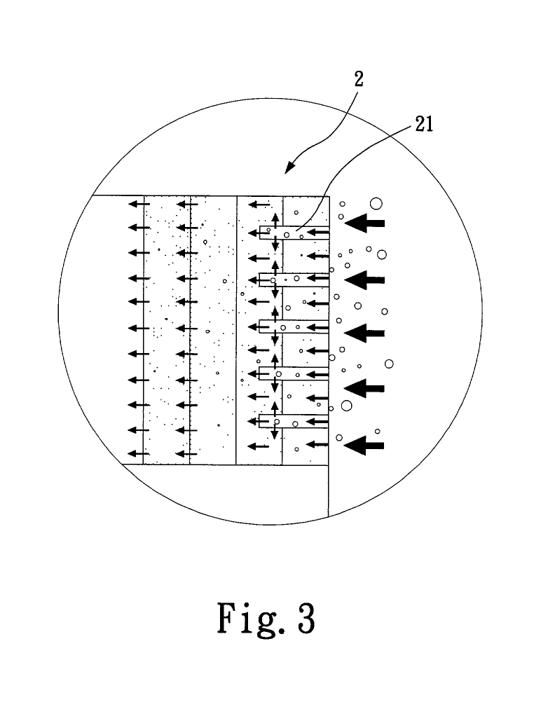

Please refer to FIG. 2 that is a fragmentary sectional view of a filter element 2 of the present invention, and to FIG. 3 that is a partially enlarged view of FIG. 2. As shown, the filter element 2 includes a plurality of layers of filtering materials of different compactness that are densely overlaid layer by layer. A plurality of surface holes 21 having predetermined depths are formed on an upper part of the filtering materials at where water is introduced into the filter element 2 to flow downward into deep layers of filtering materials of the filter element 2.

Typically, the filter element 2 is so designed that the compactness of the filtering material gradually decreases from a surface layer to other deeper layers, so that large-size impurities in the water are immediately filtered at the surface layer, while other small-size impurities are separately filtered at different deep layers of filtering materials when the water flows through the filter element 2.

The provision of the surface holes 21 allows a part of water to bypass an uppermost surface of the overlaid filtering materials and directly flow into inner layers of the filter element 2 via the surface holes 21. Small-size impurities in the water are therefore directly filtered at the deep layers of filtering materials. However, it is to be noted that the water passing the surface holes 21 does not rush toward the deep layers below the surface holes 21 but diffuses via an inner wall surface of each surface hole 21. Therefore, the surface holes 21 indirectly form additional water passages in the filter element 2 to guide water into the filtering materials in different directions. The surface holes 21 are helpful in separation of the introduced water into different directions to reduce a flow resistance of the water in the filtering materials. The surface holes 21 also provide increased impurity deposit areas in the filter element 2 to extend a service life of the filter element 2 and speed up the purification of water with the filter element 2. It can also be assured that water being filtered with the filter element 2 of the present invention is impurity-free.

The filtering materials employed in the filter element 2 of the present invention do not necessarily have different compactness. A plurality of layers of the same type of filtering material providing uniform compactness may also be densely overlaid to form the filter element 2 of the present invention.

With the surface holes 21 provided on the upper part of the filtering materials of the filter element 2, water can be introduced to pass the filter element 2 at a reduced flow resistance that allows the water to flow through the filter element 2 under a reduced water pressure and still permit large-size impurities to quickly seat on the upper surface of the first layer of filtering material in the filter element 2. In the case the large-size impurities are filtered at the surface holes 21 and clog some of them, the water introduced into the filter element 2 is able to diffuse through the filter element 2 via other surface holes 21 without reducing water volume that could pass through the filter element 2. It is not necessary to increase the pressure of water introduced into the filter element 2 to force the water through the layers of filtering materials. The surface holes 21 not only increase the areas for introducing water into the filter element 2 but also provide extended water passages that are less easily clogged by the large-size impurities continuously deposited on and pressed against the filtering materials and therefore enable a prolonged service life of the filter element 2.

The filter element 2 and the surface holes 21 thereof are not limited to any specific configuration and may be produced depending on the die with which the filter element 2 is manufactured. Moreover, the filter element 2 may be a single-layer or a multi-layer structure without specific configuration.

The present invention has been described with a preferred embodiment thereof and it is understood that many changes and modifications in the described embodiment can be carried out without departing from the scope and the spirit of the invention as defined by the appended claims.

What is claimed is:

1. A water-purifying filter element having surface holes for deep filtration, comprising a plurality of filtering materials and a plurality of surface holes of predetermined depths formed at an upper part of said filtering materials at where water is introduced into said filtering materials for purification purpose; said surface holes providing additional water passages at the upper part of the filtering materials and guiding the water introduced into said filter element toward different directions to reduce a flow resistance thereof, and increasing impurity-deposit areas in said filter element to extend a service life of said filter element and speed up purification of the introduced water with said filter element.

2. The water-purifying filter element having surface holes for deep filtration as claimed in claim 1, wherein said plurality of filtering materials of said filter element are arranged in the form of multiple overlaid layers.

3. The water-purifying filter element having surface holes for deep filtration as claimed in claim 2, wherein said filtering materials at different layers have different compactness from one another.

4. The water-purifying filter element having surface holes for deep filtration as claimed in claim 1, wherein said filtering materials have the same compactness.
